(19) United States
(12) Patent Application Publication
(10) Pub. No.: US 2026/0241300 A1
(43) Pub. Date: Aug. 20, 2026

(54) SYSTEMS AND METHODS FOR ACTUATOR-CONTROLLED WHEEL ASSEMBLIES

(71) Applicant: Universal City Studios LLC, Universal City, CA (US)

(72) Inventor: Michelle Smith, Orlando, FL (US)

(21) Appl. No.: 19/537,097

(22) Filed: Feb. 11, 2026

Related U.S. Application Data
(60) Provisional application No. 63/758,669, filed on Feb. 14, 2025.

(51) Int. Cl. A63G 31/16; A63G 31/02; B60B 35/10

(52) U.S. Cl. CPC A63G 31/16; A63G 31/02; B60B 35/1054

(57) ABSTRACT

In certain embodiments, a wheel assembly system of a ride vehicle, including a sensor system including one or more sensors, a wheel assembly including a plurality of wheels configured to contact a ride track, one or more actuators, and a controller having a memory and a processor. The controller is communicatively coupled to the one or more actuators, and to the sensor system, and the controller is configured to direct a ride vehicle along the ride track, receive a feedback from the sensor system, the feedback indicative of a location of the ride vehicle on the ride track, and cause an adjustment of one or more actuators of the wheel assembly based on the location of the ride vehicle on the ride track to adjust an amount of force applied to the ride track by one or more wheels of the plurality of wheels.

### CROSS REFERENCE TO RELATED APPLICATION(S)

This application claims priority to and the benefit of U.S. Provisional Application Serial No. 63/758,669 entitled “SYSTEMS AND METHODS FOR ACTUATOR-CONTROLLED WHEEL ASSEMBLIES” and filed on February 14, 2025, which is expressly incorporated by reference herein in its entirety.

### BACKGROUND

The present disclosure relates generally to a system and method for actuator-controlled ride vehicle wheel assemblies.

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

Amusement parks regularly include attractions with ride vehicles that run along tracks and carry one passenger or multiple passengers through the attraction. The ride vehicles sometimes include wheel assemblies that grip the tracks to secure the ride vehicle to the track while being guided along the ride path. Over time, ride vehicles have progressively become faster, more immersive, and designed to hold more riders. As the aforementioned changes have emerged, ride vehicle wheel assemblies regularly experience larger amounts of force. As such, improved methods for maintaining wheel assembly grip on the tracks of amusement rides are required.

### BRIEF DESCRIPTION

Certain embodiments commensurate in scope with the originally claimed subject matter are summarized below. These embodiments are not intended to limit the scope of the disclosure. Indeed, the present disclosure may encompass a variety of forms that may be similar to or different from the embodiments set forth below.

In certain embodiments, a wheel assembly system of a ride vehicle, including a sensor system including one or more sensors, a wheel assembly including a plurality of wheels configured to contact a ride track, one or more actuators, and a controller having a memory and a processor. The controller is communicatively coupled to the one or more actuators, and to the sensor system, and the controller is configured to direct a ride vehicle along the ride track, receive a feedback from the sensor system, the feedback indicative of a location of the ride vehicle on the ride track, and cause an adjustment of one or more actuators of the wheel assembly based on the location of the ride vehicle on the ride track to adjust an amount of force applied to the ride track by one or more wheels of the plurality of wheels.

In certain embodiments, a method for managing traction of a wheel assembly of a ride vehicle on an attraction track, the method including directing, via a controller, a ride vehicle along the attraction track, receiving, via the controller, a feedback from a sensor system, the feedback indicative of a location of the ride vehicle on the attraction track, and causing, via the controller, an adjustment of one or more actuators of the wheel assembly of the ride vehicle based on the location of the ride vehicle on the track to adjust an amount of force applied to the ride track by one or more wheels of the plurality of wheels.

In certain embodiments, a tangible and non-transitory machine-readable medium including instructions to operate a pinch wheel force management system. The pinch wheel force management system includes one or more sensors and a controller coupled to the one or more sensors. The controller includes a processor, a memory, and instructions stored on the memory and executable by the processor. The pinch wheel force management system is configured to direct a ride vehicle along a ride track receive a feedback from the one or more sensors, the feedback indicative of a location of the ride vehicle on the ride track, and cause an adjustment of one or more actuators of a wheel assembly based on the location of the ride vehicle on the ride track to adjust an amount of force applied to the ride track by one or more wheels of the plurality of wheels.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a profile view of a three-direction wheel assembly, in accordance with an embodiment of the present disclosure;

FIG. 2 is a schematic diagram of a profile view of a three-direction wheel assembly showing corresponding force arrows, in accordance with an embodiment of the present disclosure;

FIG. 3 is a profile view of a two-direction pinch wheel assembly showing corresponding force arrows, in accordance with an embodiment of the present disclosure;

FIG. 4 is a front-view of a ride carriage and corresponding wheel assemblies on track rails; in accordance with an embodiment of the present disclosure;

FIG. 5 is a block diagram of a wheel force management system, in accordance with an embodiment of the present disclosure;

FIG. 6 is a flowchart illustrating a method of controlling the grip of the wheel assembly on the track, in accordance with an embodiment of the present disclosure; and

FIG. 7 is a flow chart illustrating a method of controlling the grip of the wheel assembly on the track, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is directed to an actuator-controlled wheel assembly, e.g., a ride vehicle wheel assembly, and a corresponding wheel force management system. The actuator-controlled wheel assembly and corresponding wheel force management system may advantageously operate in a variety of attractions, such as fast attractions, attractions with sharp turns, attractions in which ride vehicles carry heavy loads, and any other attraction in which the ride vehicle may experience large amounts of force or may exert large amounts of force on the ride track. However, the wheel force management system may also operate in attractions in which the ride vehicle may experience or exert average or smaller than average amounts of force. The wheel force management system may be used for one, some, or all of the wheel assemblies on a ride vehicle, based on the predicted forces the ride may exert on the ride vehicle and vice versa. For example, an individual ride cycle of an attraction may include certain portions along curves, faster portions, and/or portions in which the ride vehicle may experience internal shaking or rocking as part of an immersive experience. For a preprogrammed ride, these portions may occur at predetermined locations or times of the ride cycle. For a more dynamic ride or for a ride that receives operator or user input to change ride conditions, these portions may vary depending on the particular inputs to the ride conditions of each individual ride cycle. Accordingly, a desired force applied by the wheel assemblies to the track may vary within an individual ride cycle and/or may vary between individual ride cycles.

As provided herein, the force management system may operate to activate actuators to cause the wheel assemblies to grip the track more tightly in conjunction with portions of the ride cycle during which more force may be desired. In an embodiment, a control system to more precisely manage and tune applied forces for wheel assemblies of a ride vehicle via dynamic control, which permits higher forces to be applied on curves or strategic locations along a ride track while relatively lower forces can be applied at other locations of the ride track during a ride cycle. Thus, overall wheel wear may be reduced, because a total maximum gripping force may be reduced.

Conventional pinch wheel assemblies feature one or more wheels on three sides of the rail of the track. The assemblies may feature at least one wheel positioned on top of the track (e.g., running wheels, road wheels, tractor wheels, etc.), at least one wheel under the track (e.g., upstop wheels, underfriction wheels, or uplift wheels), and at least one wheel positioned either on the interior of the rails or exterior (e.g., side friction wheels). The position of the side friction wheels may depend on the layout of the attraction and the ride. Pinch wheel assemblies facilitate more aggressive inclines, the option to twist and invert the ride vehicle, and similar features that increase the thrill of an attraction compared to early roller coasters. To assist the wheels in a pinch wheel assembly (e.g., wheel assembly) maintain traction with the track, the wheel assembly may include one or more springs designed to counteract forces pulling the ride vehicle away from the track. However, springs have a fixed force profile and cannot be adjusted dynamically.

The disclosed pinch wheel assemblies and force management system may instead utilize controller-based actuation to maintain contact and traction of the ride vehicle with the track in a dynamically adjustable manner. In some embodiments, the force management system may include wheel assemblies, e.g., pinch wheel assemblies, that include one or more running wheels, one or more upstop wheels, and one or more side friction wheels. The side friction wheels may be interior to the track rails or exterior to the track rails based on the configuration, speed, and the like of the attraction. There may be actuators coupled to one or more of the wheels (e.g., running wheels, upstop wheels, side friction wheels), wheel sets, or wheel assemblies and the frame of the ride vehicle. The actuators may be preprogrammed based on the map or model of the attraction, the actuators may be adjusted in real time based on sensor feedback, or both. The inclusion of actuators instead of or in conjunction with springs may provide support for the ride vehicle and its wheel assembly under high forces both generally and for extended periods of time before replacement.

In some embodiments, the pinch wheel force management system may include one or more running wheels or one or more upstop wheels, but no side friction wheels. Instead, the running wheels and upstop wheels may be angled such that either the upstop wheels or the running wheels act as a side friction wheels as well. As such, the running wheels and/or upstop wheels may be angled such that they are offset by anywhere from 90 degrees to 180 degrees from each other in any fashion capable of supporting the ride vehicle’s weight through the different segments of the ride track. Further, the running wheels and upstop wheels may be angled to the interior or exterior of the track based on the track layout and predetermined forces of the ride vehicle on the track and vice versa.

The pinch wheel force management system may include a sensor system designed to sense the forces of the ride vehicle on the track and the forces of the track on the ride vehicle and to dynamically adjust forces of the wheel assemblies to return to a preset value or to remain within a preset range. Further, the sensor system may include sensors to detect the amount of traction and contact the ride vehicle has with the track. The sensors may be located along the frames, near the pinch wheel assembly, on the pinch wheel assembly, on the track, or a combination thereof. As the ride vehicle moves along the track, the sensor system may receive feedback indicative of the tilt, location, and speed of the ride vehicle, as well as the forces exerted on one or more sections of the ride vehicle and the traction of the wheels with the track. The force management system may use the drive motor package to direct the pinch wheel assemblies of the ride vehicle along the track of the attractions. As the ride vehicle moves along the track, the pinch wheel force management system may sense one or more indicators of traction or contact between the ride vehicle and the track through the sensor feedback. This indication may arise at a steep incline, a sharp curve, a fast turn, or the like. The controller of the force management system may receive feedback from the sensor system regarding traction or contact and may control the actuators of one or more of the pinch wheel assemblies to adjust the pinch wheel assemblies into a desired level of contact or traction with the rail of the track. The controller may adjust one or more actuators per wheel assembly based on a desired traction profile with the track. For example, the desired traction profile may adjust inside curve wheel assemblies to apply a different amount of force relative to outside curve wheel assemblies to promote smooth transitions through a curve. Even further, each different wheel of an individual wheel assembly may be affected by actuation such that running, friction, and upshot wheel traction may be individually tuned via differential actuation to cause more or less force to be applied. Once the ride vehicle exits the maneuver associated with the adjusted traction profile, the force management system may control the actuators to release the force the actuators applied through the last maneuver to accommodate a new portion of the track, which may be associated with a different traction profile.

In some embodiments, the pinch wheel force management system may include a mapping system configured to map expected or desired forces exerted on the ride vehicle by the track and on the track by the ride vehicle. The mapping system may include information about the track, such as the length of the track and the tilt, incline, width, and curve at each location along the track. The mapping system may also include information about the ride vehicle, such as the dimensions of the ride vehicle, the unloaded weight of the ride vehicle, and the average weight of the ride vehicle when loaded. Additionally, the mapping system may include information about the target or predetermined speed and acceleration at each location along the track. The mapping system may use this information to predetermine the actuator settings for each location along the track, so that as the ride vehicle approaches each location, the actuators set themselves to account for the predetermined forces exerted on the ride vehicle by the track and on the track by the ride vehicle to maintain adequate traction of the ride vehicle with the track. In some embodiments, the weight of the ride vehicle may be assessed by sensors in the wheel assembly prior to each ride, and calculations may be made to adjust the actuator settings for each location accordingly.

In some embodiments, the pinch wheel force management system may make adjustments to the actuator settings during a ride cycle based on a deviation between actual forces and traction between the ride vehicle and the track, via sensor data, and the forces and traction predetermined by the mapping system. As the ride vehicle approaches a new location, the mapping system may instruct the controller to adjust the actuators to account for the predetermined forces at the new location. As the ride vehicle enters the new location, if the sensors detect the forces are outside of the predicted forces range, the force management system may control the actuators to maintain adequate traction with the track based on the actual forces between the track and the ride vehicle. Maintaining adequate traction may provide for a smoother ride experience and limit the amount of wear on the track and ride vehicle from excess traction. Excess traction may also consume excess energy because the attraction would use more power to achieve the same ride velocity due to excess friction.

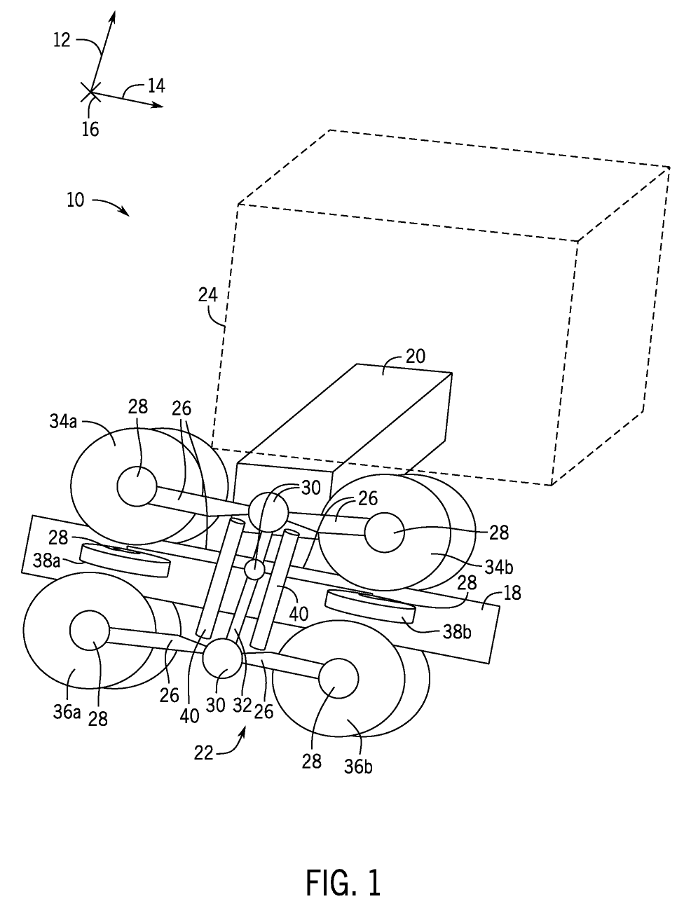

With the preceding in mind, FIG. 1 is a schematic diagram of a profile view of a three-direction wheel assembly 10. For purposes of discussion, reference may be made to a longitudinal direction or axis 12, a latitudinal direction or axis 14, and transverse direction or axis 16. The wheel assembly 10 is resting on a rail 18, which may be part of the track. Coupling two or more-wheel assemblies may be a carriage 20, which may sit in the transverse direction 16 relative to the rails 18. The carriage 20 may be coupled to the frame 22 of the wheel assembly 10. Further, the carriage 20 may support the passenger cart 24. The carriage 20 may either fully or partially support the passenger cart 24.

The frame 22 may include one or more supports 26 for each wheel of the wheel assembly 10. The supports 26 may couple to an axle 28 on each wheel. When there are two or more of each wheel (e.g., top wheels, side wheels, bottom wheels), there may be one or more pivot points 30, coupling the latitudinal supports 26 for each of the wheels 34, 36, 38 to each other. The pivot points 30 may also couple the different types of wheels via one or more longitudinal supports 32. The pivot points 30 may provide for movement in the frame 22 controlled by the one or more actuators 40, which is described in more detail below. Further, the pivot points 30 may prevent a support on one latitudinal side of the pivot point 30 from moving the coupled wheel away from the rail 18 when the support on the other latitudinal side of the pivot point 30 compresses the wheel into the rail 18.

The illustrated wheel assembly 10 includes six wheels total: two running wheels 34a, 34b, two upstop wheels 36a, 36b, and two side friction wheels 38a, 38b. In some embodiments, there may be one running wheel 34, one upstop wheel 36, and one side friction wheel 38. In still other embodiments, there may be three or more running wheels 34, three or more upstop wheels 36, and three or more side friction wheels 38. Some embodiments may have varying numbers of each type of wheel based on the uses of the wheel assembly 10 in the attraction. For example, the wheel assembly may have three running wheels In certain embodiments, a wheel assembly system of a ride vehicle, including a sensor system including one or more sensors, a wheel assembly including a plurality of wheels configured to contact a ride track, one or more actuators, and a controller having a memory and a processor. The controller is communicatively coupled to the one or more actuators, and to the sensor system, and the controller is configured to direct a ride vehicle along the ride track, receive a feedback from the sensor system, the feedback indicative of a location of the ride vehicle on the ride track, and cause an adjustment of one or more actuators of the wheel assembly based on the location of the ride vehicle on the ride track to adjust an amount of force applied to the ride track by one or more wheels of the plurality of wheels., three upstop wheels 36, and two side friction wheels 38.

The rails 18 of the track may be any configuration providing support for the wheel assembly 10 and the ride vehicle. In some embodiments, the rails 18 of the track may be round or substantially curved. The wheel assembly 10 may balance on the rounded track. A round or substantially curved track may limit the amount of bending the track does to accomplish the desired ride maneuvers. In other embodiments, the rails 18 of the track may be rectangular, triangular, or any other shape with flat edges. The wheels of the wheel assembly 10 may rest either on a corner coupling two edges or on a flat edge, depending on the shape of the wheel, as described in more detail below. A rail 18 with flat edges may provide a more defined surface for the wheels of the wheel assembly to rest and press against during ride maneuvers.

The wheels on the wheel assembly 10 may take on a variety of shapes and sizes to accommodate the shape and size of the rail 18, the desired ride maneuvers, and the traction the wheels may experience. In some embodiments, the wheels may all be the same size. This may assist the actuators 40 with maintaining equivalent compression and traction between the wheels of the wheel assembly 10 and the rail 18, as the force exerted by the actuators 40 onto the wheels may be distributed over a similar amount of rail 18. However, in some embodiments, the wheels may be one or more different sizes based on the ride maneuvers the attraction includes. For example, in attractions with steeper ascents, it may be advantageous for the running wheels 34 and the upstop wheels 36 to be larger than the side friction wheels, as the upstop wheels 36 and running wheels 34 may participate more in maintaining traction with the rails 18. In contrast, in attractions with sharper turns and fewer steep ascents or descents, it may be advantageous for the side friction wheels 38 to be larger than the upstop wheels 36 and the running wheels 34 to maintain traction of the wheel assembly 10 with the rail 18 during curve maneuvers.

The wheels of the wheel assembly 10 may be shaped in a way to encourage traction with the rail 18. In other embodiments, some or all of the wheels may have a groove to wrap the edges of the wheels around the rail 18, as displayed in the illustrated embodiment. As such, the center line of the wheel may rest on the rail 18, with the outer edges of the wheel resting on either side of the rail 18. The outer edges may be such that the outer edges do not touch the side friction wheels 38, if any. The depth of the groove may depend on the size of the rail 18, the weight of the ride vehicle, the desired surface area of contact between the wheel assembly and the rail, and the like. In embodiments where the side friction wheels 38 have a groove and wrap around the rail 18, the running wheels 34 and upstop wheels 36 may not have grooves to provide space for the edges of the side friction wheels 38. The depth of the groove may depend on factors such as weight of the ride vehicle, sharpness of turns, the actuator’s 40 capabilities, and the like. In some embodiments, the wheels in the wheel assembly 10 may not include grooves. Rather, the wheel assembly 10 may rely on the actuators 40 to maintain traction between the wheels of the wheel assembly 10 and the rails 18.

The number of wheels in the wheel assembly 10 may vary based on factors such as weight of the ride vehicle, shape of the ride vehicle, sharpness of turns, the actuator’s 40 capabilities, inversions in the ride vehicle, and the like. In some embodiments, there may be as few as two wheels in the wheel assembly 10. In embodiments with only two wheels on the wheel assembly 10, the wheels may be positioned such that the ride vehicle may balance on the rails 18. The wheel assembly 10 may have its wheels positioned at between a 90-degree and 180-degree angle in any direction. Embodiments with only two wheels in the wheel assembly 10 may benefit from each wheel assembly 10 of a ride vehicle having a different wheel configuration. For example, one wheel assembly may have its two wheels sitting directly across the rail 18 from each other at a 180-degree angle in the longitudinal direction 12, while a second wheel assembly has its two wheels sitting directly across the rail 18 from each other at a 180-degree angle in which each wheel is offset from the longitudinal direction 12 by 45 degrees.

In other embodiments, there may be at least three sets of wheels in the wheel assembly 10. As discussed above and as illustrated, these wheel assemblies 10 may include running wheels 34, upstop wheels 36, and side friction wheels 38. However, the wheel assemblies may instead include two sets of side friction wheels 38 (e.g., one set on the interior of the rail 18 and one set on the exterior of the rail 18) and either one set of upstop wheels 36 or one set of running wheel 34. The placement of the wheels on the wheel assemblies 10 may be based on the weight of the ride vehicle, shape of the ride vehicle, sharpness of turns, the actuator’s 40 capabilities, inversions in the ride vehicle, and the like. Each set of wheels may include one or more wheels. In some embodiments, each set of wheels may have the same number of wheels regardless of placement along the rail 18. In other embodiments, one or more sets of wheels may have a different number of wheels. For example, there may be two wheels in the running wheel 34 set and the upstop wheel 36 set, but one wheel in the set of side friction wheels 38.

In still other embodiments, there may be more than three sets of wheels in the wheel assembly 10. The amount of wheel sets may be based on the shape of the rails 18 (e.g., round, square, pentagonal, hexagonal, etc.), weight of the ride vehicle, shape of the ride vehicle, sharpness of turns in the track, the actuator’s 40 capabilities, inversions in the ride vehicle, and the like. The amount of wheels in a wheel assembly 10 may impact the amount of traction the wheel assembly 10 has, and how many actuators 40 the force management system uses.

The actuators 40 may apply force to one or more wheels in a wheel assembly 10 to maintain adequate contact and traction between the wheel assemblies 10 and the rail 18. The number of actuators 40 in a wheel assembly 10 may be based on the weight of the ride vehicle, sharpness of turns of the track, the angle of the ascents and descents of the track, the actuator’s 40 capabilities, the number of wheel assemblies 10, the configuration of the wheel assemblies 10, inversions in the ride vehicle, and the like. The actuators may couple to the wheel assembly 10 such that, when activated, the actuators compress to pull the supports 26, 32 of the wheels such that the wheels contact the rail 18. The actuators 40 may stretch along supports 26, 32, between the frame 22 and supports 26, 32, between the axles 28 of the side friction wheels 38 and the frame 22, or in any other location suitable to control the distance of one or more wheels of the wheel assembly 10 against the rail 18. In some embodiments, the actuators 40 may be used in conjunction with springs.

In some embodiments, there is one actuator 40 per wheel in each wheel assembly 10 such that wheel can be individually addressed. In some embodiments, there is one actuator 40 per set of wheels in each wheel assembly 10 such that each set of wheels can be individually addressed. For example, if the wheel assembly includes three sets of wheels (e.g., a set of two running wheels 34, a set of two upstop wheels 36, and a set of two side friction wheels 38), there may be one actuator 40 for both running wheels 34, one actuator for both upstop wheels 36, and one actuator 40 for both side friction wheels 38. This configuration may be advantageous when the wheels of the wheel assembly 10 are close enough together that one actuator 40 affects the position of both wheels of the set of wheels, or when the forces experienced by the wheel assembly 10 are small enough that one actuator 40 per wheel set may maintain contact between the wheel set and the rails 18.

In some embodiments, there is only one actuator 40 per wheel assembly 10. The actuator 40 may affect only one wheel or set of wheels or may be coupled to a frame coupling two directly opposing sets of wheels (e.g., running wheels 34 and upstop wheels 36, side friction wheels 38 on both sides of the rail 18, etc.). As such, when the actuator 40 contracts, the supports 26 for both sets of wheels may flex or pivot at the pivot points 30, bringing the wheels back into contact with the rail 18. Conversely, in some embodiments, there are actuators 40 only where excess forces are predetermined in each ride vehicle. These actuators 40 may be located on frames or supports to actuate based on the predetermined forces on the wheel assemblies 10. For example, based on the ascents, descents, curves, and inversions of the track, as well as the weight of the ride vehicle, the forces on the wheel assemblies may be such that only one wheel assembly 10 may temporarily lose contact with the track without adjustment, or control of one wheel assembly 10 may indirectly exert sufficient control over the other wheel assemblies 10. As such, there may only be one actuator 40 strategically placed on one wheel assembly 10 for the entire ride vehicle.

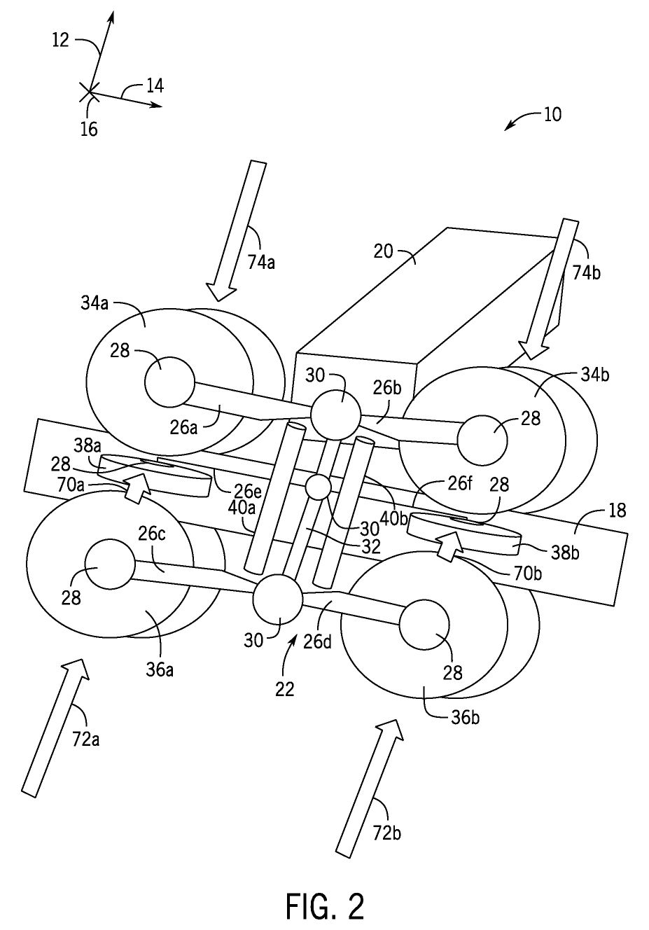

FIG. 2 is a schematic diagram of a profile view of a three-direction pinch wheel assembly (e.g., three-direction wheel assembly) 10 with corresponding force arrows 70, 72, 74. The force arrows 70, 72, 74 indicate the direction the forces are applied when the actuators 40 operate (e.g., are in use) to adjust a force applied by the respective wheel or set of wheels towards the track. It should be understood that the actuators may additionally or alternatively apply force in an opposing direction to reverse or deactivate an applied actuation and decrease a force applied by the respective wheel or set of wheels towards the track. It should be noted that there may be a third and fourth actuator 40c and 40d in a wheel assembly 10 that affects the side friction wheels 38c and 38d. The third and fourth actuators 40c and 40d may stretch in the transverse direction 16. The third and fourth actuators 40c and 40d may couple the frame 22 to the carriage 20 or another section of the frame 22 to pull side friction wheels 38c and 38d into the rails or push the side friction wheels 38c and 38d into the rails 18 if the side friction wheels 38c and 38d are on the interior of the rails 18. As such, the third and fourth actuators 40c and 40d, and side friction wheels 38c and 38d, are not visible in the illustrated embodiment, as other features are covering their location. In the illustrated embodiment, actuation of the actuators 40a and 40b affecting the side friction wheels 38a, 38b may flex the supports 26e, 26f to pull the side friction wheels 38a, 38b into contact with the rail 18 via forces in the transverse direction 70a, 70b.

The forces, represented by force arrows 72, 74 in the longitudinal direction 12 are determined by actuators 40a, 40b in the longitudinal direction 12. If the actuators 40a, 40b in the longitudinal direction 12 are coupled to opposing supports 26a and 26c, 26b and 26d then both the running wheels 34a, 34b and the upstop wheels 36a, 36b on the same side of longitudinal support 32 may flex or bend at pivot points 30 to maintain contact of wheels 34a and 36a, 34b and 36b with the rail 18. Conversely, the actuators 40 may couple to part of the frame 22 that is not a support 26 for another wheel, which may provide the wheel assembly to actuate one wheel instead of opposing wheels (e.g., running wheels 34 and upstop wheels 36). For example, if actuator 40a in the illustrated embodiment contracted, it may pull both the running wheel 34a and the upstop wheel 36a into the rail 18 using forces 74a and 72a, respectively. However, if actuator 40b is coupled between support 26b and another piece of frame 22, as the actuator 40b contracts, the running wheel 34b may be pulled into the rail 18 by force 74b, but force 72b would not exist because actuator 40b would not significantly affect support 26d to pull wheel 36b into the rail 18 as well.

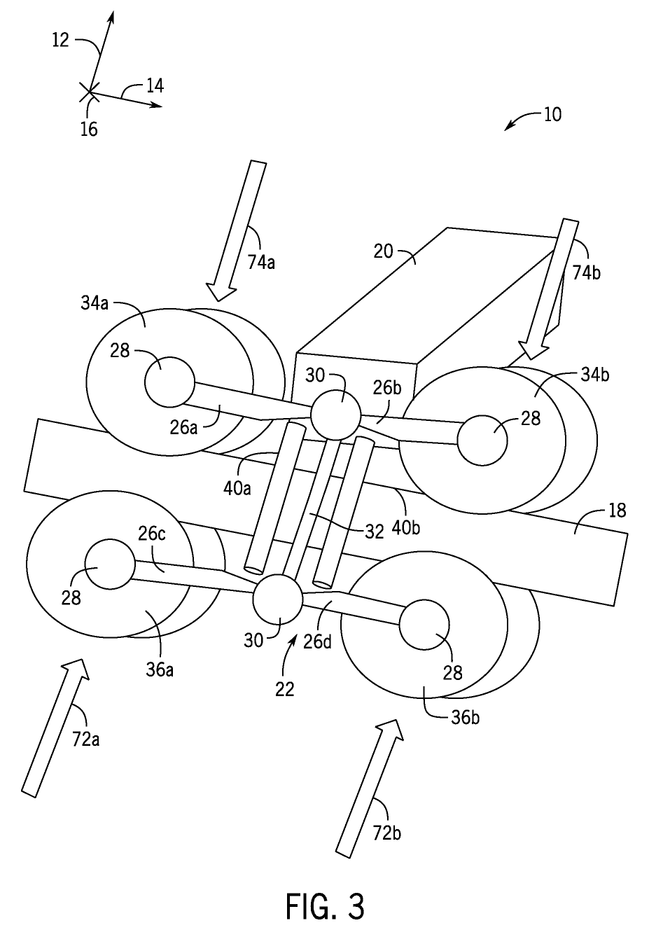

FIG. 3 is a schematic of a profile view of a two-direction pinch wheel assembly (e.g., wheel assembly) 10 with corresponding force arrows 72, 74. In the illustrated embodiment, the wheel assembly 10 features two running wheels 34a, 34b and two upstop wheels 36a, 36b and does not include any side-friction wheels. As described in FIG. 1, this embodiment may only include two sets of wheels in the wheels assembly 10. As such, the wheels in the wheel assembly 10 may have deeper grooves or may benefit from stronger actuators 40 to maintain contact between the wheel assembly 10 and the rail 18. The wheels may be organized in any two-wheel set configuration described in the detailed description of FIG. 1. In the illustrated embodiment, the forces, represented by force arrows 72, 74, in the longitudinal direction 12 are determined by actuators 40a, 40b in the longitudinal direction 12. If the actuators 40a, 40b in the longitudinal direction 12 are coupled to opposing supports 26a and 26c, 26b and 26d then both the running wheels 34 and the upstop wheels 36 on the same side of longitudinal support 32 may flex or bend at pivot points 30 to maintain contact of wheels 34a and 36a, 34b and 36b with the rail 18. Conversely, the actuators 40 may couple to part of the frame 22 that is not a support 26 for another wheel, which may provide the wheel assembly to actuate one wheel instead of opposing wheels (e.g., running wheels 34 and upstop wheels 36). For example, if actuator 40a in the illustrated embodiment contracted, it may pull both the running wheel 34a and the upstop wheel 36a into the rail 18 using forces 74a and 72a, respectively. However, if actuator 40b was coupled between support 26b and another piece of frame 22, as the actuator 40b contracts, the running wheel 34b may be pulled into the rail 18 by force 74b, but force 72b would not exist because actuator 40b would not affect support 26d to pull wheel 36b into the rail 18 as well.

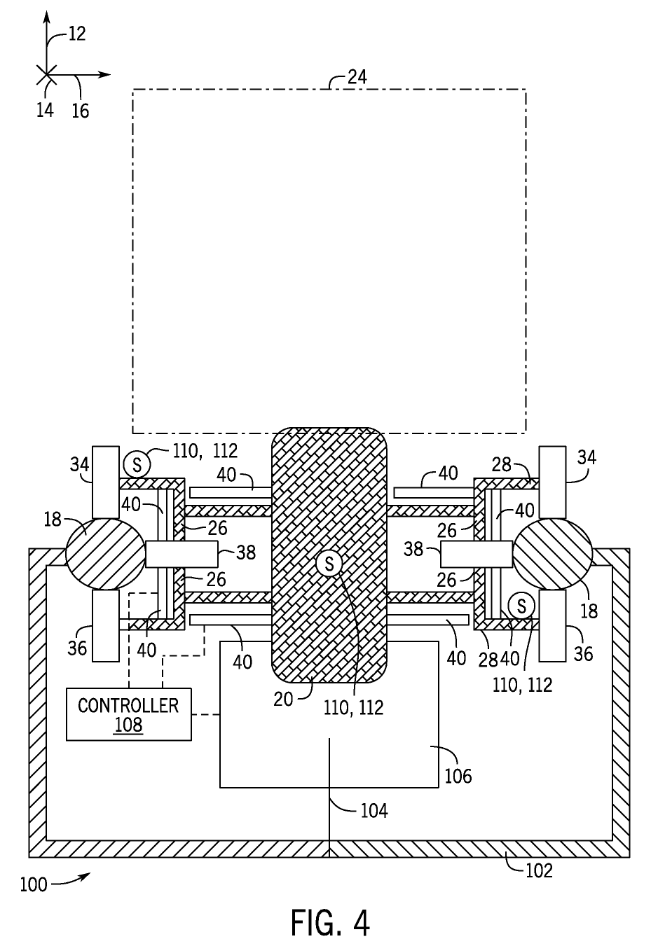

FIG. 4 is a schematic of a front-view of the carriage 20 and corresponding wheel assemblies 10 (FIGS. 1-3) on rails 18 of a track 100. The track 100 may include track supports 102 that couple the rails 18 and create an empty space between the rails 18 for the ride vehicle to rest. As described in the description for FIG. 1, the wheels of the wheel assembly 10 may be a variety of configurations (e.g., angles, interior vs exterior side friction wheels 38, etc.) and sets of wheels. In the illustrated embodiment, each wheel assembly 10 has three sets of wheels with interior side friction wheels 38. The track 100 may also include a fin 104, which may assist the ride vehicle with braking. The ride vehicle may couple to the track 100 by the wheel assembly’s 10 connection to the rails 18, and by the drive motor package’s 106 connection to the fin 104. The drive motor package 106 may include the electric motor, gearbox, and other electrical equipment needed to operate the attraction.

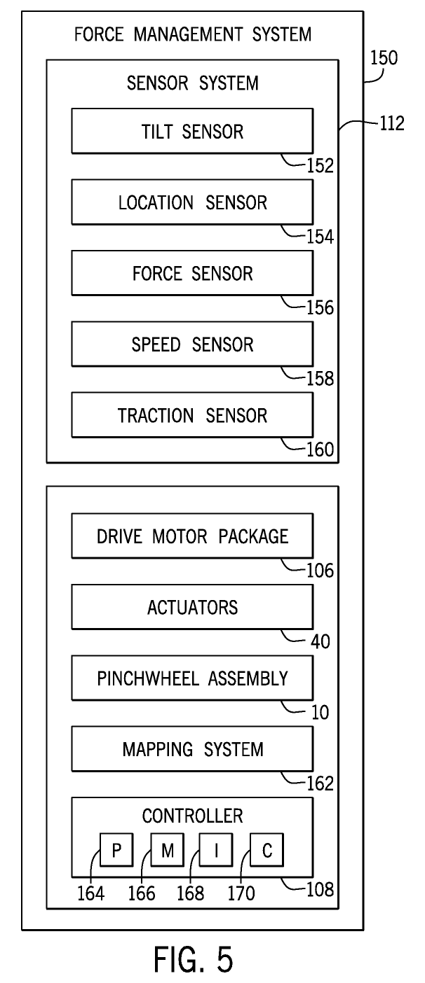

In the illustrated embodiment, a controller 108 is separately coupled to the force management system. In other embodiments, the drive motor package 106 also includes the controller 108 for the force management system. The controller 108 may be coupled to every actuator 40 regardless of the number of actuators 40 in the pinch wheel force management system. Further, the controller 108 may be coupled to the sensors 110 of the sensing system 112. The sensors 110 in the illustrated embodiment are located in the carriage 20, on the axel of an upstop wheel 36, and on the axel of a running wheel 34. However, the sensor 110 placement may be based on the type of sensor (e.g., tilt sensor, location sensor, force sensor, speed sensor, traction sensor, etc.). Each sensor 110 may be located where the sensor 110 is most effective, where the sensor 110 fits on the ride vehicle, or a combination thereof. In the illustrated embodiment, there are only three marked locations for the sensor 110. However, in other embodiments there may be one sensor 110 location, two sensor 110 locations, or four or more sensor 110 locations based on the expected forces on the ride vehicle and the sensor 110 placement advantageous to achieving a smooth ride experience. The function and operations of the controller, sensing system 112, and sensors 110 is further described in the description for FIG. 5.

FIG. 5 is a block diagram of the force management system 150 and its component parts. The force management system 150 may include a sensing system 112, a drive motor package 106, one or more actuators 40, the wheel assembly 10, a mapping system 162, and a controller 108.

The sensing system 112 may include one or more sensors 110, as shown in FIG. 4. The sensors 110 may include a tilt sensor 152, a location sensor 154, a force sensor 156, a speed sensor 158, and a traction sensor 160 (e.g., a contact sensor). The tilt sensor 152 may monitor the tilt of the ride vehicle along the track 100. The tilt sensor 152 may monitor tilt in the latitudinal direction 14, longitudinal direction 12, and transverse direction 16 (FIGS. 1-4), as the direction of tilt may affect the contact of the wheels with the rail 18. As such, the tilt sensors 152 may be placed anywhere on the frame 22 (FIGS. 1-3). Further, the tilt sensors 152 may be placed on the supports 26, 32 (FIGS. 1-4) to measure the tilt of the support the wheels are on, which may indicate the amount of contact a wheel has with the rail 18 (FIGS. 1-4).

The sensing system 112 may also have a location sensor 154. The location sensor 154 may monitor the ride vehicle’s location within the attraction. If the ride vehicle include a mapping system 162, the location sensor 154 may inform the mapping system 162 of the ride vehicle’s current location in the attraction, which may be advantageous as discussed more in the discussion of the mapping system 162. The location sensor 154 may inform the mapping system 162 what element of the attraction the ride vehicle may encounter next (e.g., inversion, descent, ascent, curve, etc.). There may only be one location sensor 154 for each ride vehicle, as the ride vehicle may only have one location at a time.

Further, the sensing system 112 may include a force sensor 156. The force sensor 156 may monitor the amount of force one or more elements of the ride vehicle experiences. As such, there may be force sensors 156 anywhere the force on an element is monitored. For example, to measure the force a wheel or set of wheels is experiencing at a given time, the force sensor 156 may be on or near the wheel or set of wheels. Further, to measure the amount of force an actuator 40 expressed on an element of the ride vehicle, there may be a force sensor near the end of the actuator 40 to measure the force output.

The sensing system 112 may include one or more speed sensors 158. The speed sensors 158 may measure the speed of the ride vehicle along the track 100 (FIG. 4) or an individual element of the ride vehicle (e.g., wheels, actuator, etc.). The speed sensor 158 may inform the mapping system 162 described below how fast the ride vehicle is approaching the next location of force significance along the track 100 to control the actuator at the proper location along the track 100. The speed sensor 158 may also inform the force management system 150 how quickly the actuator 40 responds to the control to actuate so the force management system 150 may adjust when to instruct the actuators 40 to actuate.

The sensing system 112 may also include one or more traction sensors 160. The traction sensors 160 may measure the amount of traction the wheels of the wheel assembly 10 have with the rails 18. The traction sensors 160 may also measure contact instead of or in addition to traction. The traction sensors 160 may then inform the force management system 150 when the wheels have too much or not enough contact/traction, and the force management system 150 may control the actuators 40 to adjust the traction/contact. As such, there may be a traction sensor 160 on each wheel, on each set of wheels, on each wheel assembly, or where the excess forces on the wheel assembly 10 are predicted, based on the location of the actuators 40.

The drive motor package 106 may control the desired speed of the ride vehicle and power the actuators 40 and the rest of the force management system 150 to maintain contact/traction between the wheels of the wheel assemblies 10 and the rails 18. The wheel assembly 10 may be any configuration as described above in the detailed description of FIG. 1. The actuators 40 may receive instructions from the controller 108 to contract or expand to pull or push the supports 26, 32 of the frame 22 to adjust the contact and traction between the wheels of the wheel assemblies 10 and the rails 18. Too much traction may wear down the wheels and actuator 40, slow down the ride vehicle, waste electricity, provide a rough attraction experience, or the like. Not enough contact or traction may also provide a rough attraction experience, strain the rails of the track, and the like. Traditional springs may wear out quickly or not adequately control traction between ride vehicles which are heavy, part of a thrill attraction, or the like. As such, actuators 40 may provide adequate traction for extended periods of time on heavy or thrilling attractions.

The mapping system 162 may include a map or model of the ascents, descents, twists, turns, curves, and inversions of an attraction and calculate the predetermined forces on the ride vehicle at each of those locations based on the weight and speed of the ride vehicle. In some embodiments, the mapping system 162 may include information about the track 100, such as the length of the track 100 and the tilt, incline, width, and curve at each location along the track 100. The mapping system 162 may also include information about the ride vehicle, such as the dimensions of the ride vehicle, the unloaded weight of the ride vehicle, and the average weight of the ride vehicle when loaded. Additionally, the mapping system 162 may include information about the target or predetermined speed and acceleration at each location along the track 100. In some embodiments, the mapping system 162 uses information from test runs of the ride vehicle that monitors applied forces along the track 100. The mapping system 162 may use this information to predetermine the actuator 40 settings for each location along the track 100, so that as the ride vehicle approaches each location, the actuators 40 set themselves to account for the predetermined forces exerted on the ride vehicle by the track 100 and on the track 100 by the ride vehicle to maintain adequate traction of the wheel assemblies 10 with the track 100. In some embodiments, the weight of the ride vehicle may be assessed by sensing system 112 in the wheel assembly 10 prior to each ride, and calculations may be made to adjust the actuator 40 settings for each location accordingly. The model or map and associated settings from the mapping system 162 may be used by the controller 108 to track deviations from the expected forces and/or to provide control instructions for the actuators 40.

In some embodiments, the force management system 150 may make adjustments to the actuator 40 settings during a ride cycle based on a deviation between actual forces, represented by force arrows 70, 72, 74 (FIGS. 2-3), and traction between a ride vehicle and the track and the predetermined forces, represented by force arrows 70, 72, 74, and traction calculated by the mapping system 162. As the ride vehicle approaches a new location, the mapping system 162 may instruct the controller 108 to adjust the actuators 40 to account for the predetermined forces, represented by force arrows 70, 72, 74, at the new location. As the ride vehicle enters the new location, if the sensing system 112 detects the forces, represented by force arrows 70, 72, 74, are outside of the predetermined forces range, the force management system 150 may control the actuators 40 to maintain adequate traction with the track 100 based on the actual forces, represented by force arrows 70, 72, 74, between the track 100 and the wheel assemblies 10. Maintaining adequate traction may provide for a smoother ride experience and limit the amount of wear on the track and ride vehicle from excess traction. Excess traction may also consume excess energy because the attraction would use more power to achieve the same ride velocity due to excess friction.

In some embodiments, the force management system 150 may operate without the mapping system 162. In embodiments without the mapping system 162, the sensing system 112 may collect information about the track 100, such as the length of the track 100 and the tilt, incline, width, and curve at each location along the track 100. The sensing system 112 may also collect information about the ride vehicle, such as the weight of the ride vehicle when loaded. Additionally, the sensing system 112 may collect information about the speed and acceleration at each location along the track 100 and the amount of traction the wheel assemblies 10 have with the track 100 at any given time. As the sensing system 112 collects data throughout the ride cycle, the force management system 150 may receive the data collected by the sensing system 112. If the data received by the force management system 150 is indicative of a current or predetermined lack of traction (e.g., low traction sensor data, high tilt and speed data, etc.), the controller 108 of the force management system 150 may instruct one or more of the actuators 40 to contract or expand to maintain traction of the wheel assembly 10 with the track 100.

The controller 108 is configured to control operation of the actuators 40. The controller 108 includes one or more processors 164, memory 166, instructions 168, and communication circuitry 170. The communication circuitry 170 is configured to enable wired or wireless communication between the controller 108 and one or more computing devices. The processor(s) 164 may be any suitable type of computer processor or microprocessor capable of executing computer-executable code. Moreover, the processor(s) 164 may include multiple microprocessors, one or more “general-purpose” microprocessors, one or more special-purpose microprocessors, and/or one or more application specific integrated circuits, or some combination thereof. The memory 166 may also be used to store instructions 168 executed by the processor(s) 164, actuation and track 100 maps, and sensor data acquired by the sensing system 112. The memory 166 may represent non-transitory computer-readable media (e.g., any suitable form of memory 166 or storage) that may store the processor-executable code used by the processor(s) 164 to perform various techniques described herein. As illustrated, the force management system 150 includes one or more controllers 108 that communicate with and/or control data acquisition from the sensing system 112.

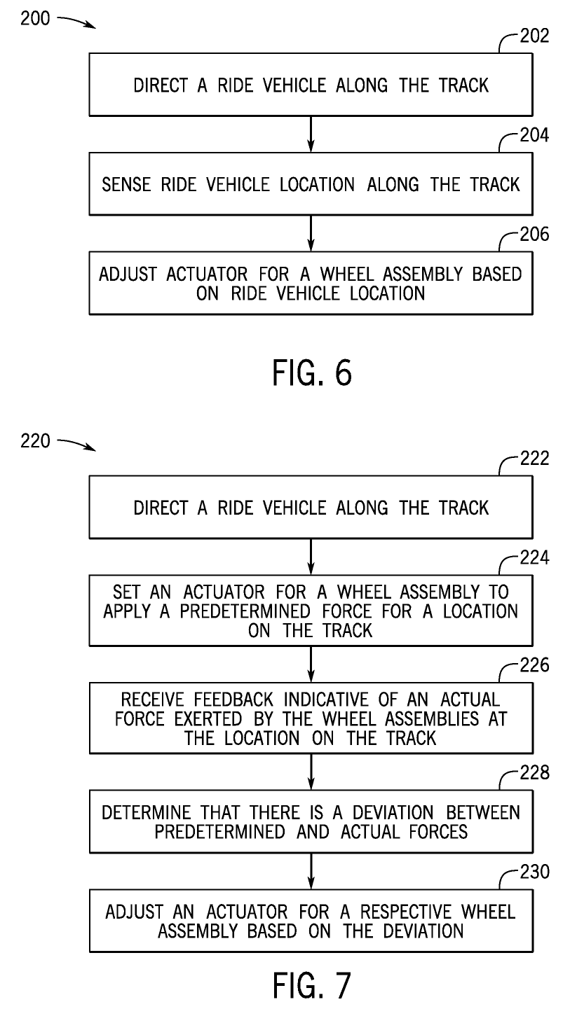

FIG. 6 is a flow chart illustrating a method 200 of controlling the grip of the wheel assembly 10 (FIGS. 1-5) on the track 100 (FIG. 4) based on the forces, represented by force arrows 70, 72, 74 (FIGS. 2-3), exerted on the ride vehicle. In block 202, the force management system 150 may direct a ride vehicle along the track 100.

In block 204, the force management system 150 (FIG. 5) may sense the ride vehicle location along the track 100. In some embodiments, the force management system 150 may sense the location using location sensors 154 (FIG. 5). In other embodiments, the force management system 150 may sense the location using the tilt sensor 152 (FIG. 5), speed sensor 158 (FIG. 5), or any other sensor 110 (FIG. 4) or combination of sensors 110 which may indicate to the force management system 150 the location of the ride vehicle along the track 100 based on the forces, represented by force arrows 70, 72, 74, experienced by the ride vehicle and the information the force management system 150 has about the track (e.g., the ascents, descents, twists, turns, curves, inversions, speed, etc.).

In block 206, the force management system 150 may adjust an actuator 40 (FIGS. 1-5) for a wheel assembly 10 based on ride vehicle location. The force management system 150 may instruct one or more actuators based on the location of the ride vehicle along the track 100 of the attraction and the pinch wheel force management system’s knowledge of the track 100 (e.g., the ascents, descents, twists, turns, curves, inversions, speed, etc.). As such, in some embodiments the force management system 150 may calculate the predetermined forces on each wheel or set of wheels of each wheel assembly at the ride vehicle location and may adjust the actuators 40 of any wheels or sets of wheels on the wheel assemblies 10 which the force management system 150 expects may lose contact/traction with the rails 18 (FIGS. 1-4) based on the predetermined forces.

Further, in certain cases, a particular ride cycle may be adjusted to generally run closer to the track or tighter to the track. In such cases, operator input may be used as part of control instructions for actuation to provide an adjustment factor, within a tolerance range, for force application.

FIG. 7 is a flow chart illustrating a method 220 of controlling the grip of the wheel assembly 10 (FIGS. 1-5) on the track 100 (FIG. 4) based on the actual and predicted forces, represented by force arrows 70, 72, 74, (FIGS. 2-3) exerted on the ride vehicle. In block 222, the force management system 150 (FIG. 5) may direct a ride vehicle along the track 100.

In block 224, the force management system 150 may set an actuator 40 (FIGS. 1-5) for a wheel assembly 10 to apply a predetermined force, represented by force arrows, 70, 72, 74 for a location on the track 100. The predetermined force, represented by force arrows 70, 72, 74, may be based on the mapping system 162 (FIG. 5) and the information it has about the attraction and its track 100 and ride vehicle (e.g., the ascents, descents, twists, turns, curves, inversions, speed, weight, etc.). The force management system 150 may set one or more actuators 40 for one or more wheels, sets of wheels, or wheel assemblies 10 to maintain traction/contact of the wheels of the wheel assembly 10 through the location based on the mapping system 162 and the predetermined forces, represented by force arrows 70, 72, 74, for the location.

In block 226, the force management system 150 may receive feedback indicative of an actual force exerted by the wheel assemblies 10 at the location on the track 100. The feedback may originate from one or more sensors 110 (FIG. 4) of the sensing system 112 (FIG. 5). The sensors providing feedback may include the tilt sensor 152 (FIG. 5), the force sensors 156 (FIG. 5), the speed sensor 158 (FIG. 5), or the traction sensor 160 (FIG. 5). The force sensor 156 may provide direct information regarding if the predetermined forces, represented by force arrows 70, 72, 74, match the actual forces, represented by force arrows 70, 72, 74, within a threshold deviation. The traction sensor 160 may provide direct information regarding how much contact/traction the wheels of the wheel assemblies 10 have. If the wheels of the wheel assemblies are not contacting the rail 18 as predetermined based on the actuator 40 settings, the force management system 150 may further actuate the actuators to achieve the desired traction/contact. The tilt sensor 152 and speed sensor 158 may work in conjunction to calculate actual forces, represented by force arrows 70, 72, 74, experienced by the wheel assemblies 10. As such, the force management system 150 may use the information received from these sensors 110 in a way substantially similar to the way the force management system 150 uses the force sensor’s 156 feedback.

In block 228, the force management system 150 may determine that there is a deviation between the predetermined and actual forces. In some embodiments, the force management system 150 may recognize a deviation if it is outside a predetermined range. The force management system 150 may provide for a percentage based or value based acceptable deviation from the predetermined forces. For example, the force management system 150 may provide for a 2-newton force deviation from the predetermined forces in each direction. If the actual forces measured by the sensing system 112 are outside of the acceptable deviation, the sensing system 112 may indicate to the force management system 150 that there is an unacceptable deviation from the predetermined forces.

In block 230, the force management system 150 may adjust an actuator 40 for a respective wheel assembly 10 based on the deviation. In some embodiments, the force management system 150 may adjust one or more actuators 40 on one or more wheels, sets of wheels, or wheel assemblies 10 based on the deviation until the sensing system 112 receives feedback indicative that the actual forces are now within the acceptable deviation range of the predetermined forces for that location on the track 100. In other embodiments, the force management system 150 may calculate the actuation adjustments to achieve the actuation settings of the predetermined forces and enact the actuation adjustments based on the calculations. The adjustment process may continue until the actual forces align with the predetermined forces, or until the ride vehicle progresses to a new location along the track 100 of the attraction and a different set of predetermined forces applicable to the wheel assemblies 10 of the ride vehicle.

While the description in FIG. 7 discusses predetermined and actual forces for each location along the track of a ride vehicle, the process may also apply to predetermined and actual contact/traction of the wheels on the rail 18. As such, the force management system 150 may adjust actuators 40 for one or more wheels in a wheel assembly 10 based on the predetermined and actual contact/traction of the wheels on the rails 18 and any deviation between the two.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A wheel assembly system of a ride vehicle, comprising;
a sensor system comprising one or more sensors;
a wheel assembly comprising a plurality of wheels configured to contact a ride track; one or more actuators; and
a controller having a memory and a processor, wherein the controller is communicatively coupled to the one or more actuators, and to the sensor system, and the controller is configured to:
direct a ride vehicle along the ride track;
receive feedback from the sensor system, the feedback indicative of a location of the ride vehicle on the ride track; and
cause an adjustment of one or more actuators of the wheel assembly based on the location of the ride vehicle on the ride track to adjust an amount of force applied to the ride track by one or more wheels of the plurality of wheels.

2. The system of claim 1, wherein the sensor system comprises a tilt sensor, a location sensor, a force sensor, a speed sensor, a traction sensor, or a combination thereof.

3. The system of claim 1, wherein the wheel assembly is a pinch wheel assembly comprising at least one or more running wheels, one or more upstop wheels, or one or more side friction wheels.

4. The system of claim 3, wherein the one or more actuators comprises a plurality of actuators configured to individually couple to at least the one or more running wheels, one or more upstop wheels, or one or more side friction wheels.

5. The system of claim 1, wherein the location of the ride vehicle on the ride track is based on a tilt of the ride track, an ascent of the ride track, a curve of the ride track, a turn of the ride track, a descent of the ride track, a twist of the ride track, or a combination thereof.

6. The system of claim 1, wherein the one or more actuators are coupled to one or more supports of the one or more wheels of the plurality of wheels.

7. The system of claim 1, wherein the location of the ride vehicle on the ride track is based on a map of the ride track stored in a mapping system of the wheel assembly system.

8. The system of claim 1, wherein each actuator of the one or more actuators adjusts at least one wheel of the plurality of wheels.

9. A method for managing traction of a wheel assembly of a ride vehicle on an attraction track, the method comprising:
directing, via a controller, a ride vehicle along the attraction track;
receiving, via the controller, a feedback from a sensor system, the feedback indicative of a location of the ride vehicle on the attraction track; and
causing, via the controller, an adjustment of one or more actuators of the wheel assembly of the ride vehicle based on the location of the ride vehicle on the attraction track to adjust an amount of force applied to the attraction track by one or more wheels of a plurality of wheels.

10. The method of claim 9, wherein the location of the ride vehicle on the attraction track is based on a tilt of the attraction track, an ascent of the attraction track, a curve of the attraction track, a turn of the attraction track, a descent of the attraction track, a twist of the attraction track, or a combination thereof.

11. The method of claim 9, wherein the one or more actuators are coupled to one or more supports of the one or more wheels of the plurality of wheels.

12. The method of claim 9, wherein the wheel assembly is a pinch wheel assembly comprising at least one or more running wheels, one or more upstop wheels, or one or more side friction wheels.

13. The method of claim 9, wherein the wheel assembly is not spring-loaded.

14. The method of claim 9, wherein the location of the ride vehicle on the attraction track is based on a map of the attraction track stored in a mapping system.

15. The method of claim 9, wherein each actuator of the one or more actuators controls at least one wheel of the wheel assembly.

16. A tangible and non-transitory machine readable medium comprising instructions to:
operate a pinch wheel force management system, wherein the pinch wheel force management system comprises one or more sensors and a controller coupled to the one or more sensors, wherein the controller comprises a processor, a memory, and instructions stored on the memory and executable by the processor, wherein the pinch wheel force management system is configured to:
direct a ride vehicle along a ride track;
receive a feedback from the one or more sensors, the feedback indicative of a location of the ride vehicle on the ride track; and
cause an adjustment of one or more actuators of a wheel assembly based on the location of the ride vehicle on the ride track to adjust an amount of force applied to the ride track by one or more wheels of a plurality of wheels.

17. The non-transitory medium of claim 16, wherein the location of the ride vehicle is based on a tilt of the ride track, an ascent of the ride track, a curve of the ride track, a turn of the ride track, a descent of the ride track, a twist of the ride track, or a combination thereof.

18. The non-transitory medium of claim 16, wherein the one or more actuators are coupled to one or more supports of the one or more wheels of the plurality of wheels. .

19. The non-transitory medium of claim 16, wherein the wheel assembly comprises one or more running wheels and one or more upstop wheels.

20. The non-transitory medium of claim 19, wherein the wheel assembly further comprises one or more side friction wheels.
